(19) United States
(12) Patent Application Publication
(10) Pub. No.: US 2005/0171734 A1
(43) Pub. Date: Aug. 4, 2005

(54) Electronic data collection system and method

(76) Inventor: Ron Dropik, Eden Prairie, MN (US)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 11/037,808

(22) Filed: Jan. 18, 2005

Related U.S. Application Data
(60) Provisional application No. 60/537,222, filed on Jan. 16, 2004.

(51) Int. Cl. G06F 15/00; G06F 17/60

(52) U.S. Cl. 702/182; 705/10; 702/188

(57) ABSTRACT

A system and method of building and implementing electronic data collection. The system and method includes a electronic data input device in communication with a manager module that registers each of the devices. Each of the devices includes a data collection application displayable to and interactable with a user. A host module resides on a server in a central location to receive and process the data from the devices. The system determines what action to take with the data based on rules defined in a builder module for specific applications. All data may be available to be queried and reported on using a query module.

### PRIORITY

This application claims the benefit of U.S. provisional patent applications Ser. No. 60/537,222 filed on Jan. 16, 2004, having the same title, which is incorporated herein by reference in its entirety.

### FIELD OF THE INVENTION

The invention relates generally to data collection, and more particularly to a hardware and software implemented electronic data collection system such as for use in surveys.

### BACKGROUND OF THE INVENTION

User or customer feedback is frequently desired by a business or other entity for a variety of reasons, including quality control and assurance, data compilation, statistical analysis, and opinion determination. For example, restaurants and hotels will often offer printed comment cards for customers to complete after a transaction or visit. Some businesses also provide surveys or other hardcopy forms to customers, either in person or sent through the mail, to generate feedback. Online businesses have the option of sending electronic mail surveys or messages with hyperlinks to web-based surveys.

Some businesses and establishments have implemented integrated voice response (IVR) systems in which a customer or user is supplied with a phone number to contact to complete an automated satisfaction survey over the telephone. For example, U.S. Pat. No. 6,487,277 describes telephone-based IVR systems. These systems may be frequently accessed by individual users, who are presented with hierarchical levels of prompts that are navigated by pressing buttons on the telephone keypad.

Hardcopy and IVR system surveys suffer from similar drawbacks. First, customer response is typically very low. Second, results from the surveys take time to compile and analyze.

In an attempt to rectify the drawbacks of hardcopy and IVR surveys, other businesses have attempted to garner customer feedback using electronic survey systems. For example, U.S. Pat. No. 4,345,345 discloses an electronic terminal for collecting opinion data from customers of an organization as to the satisfaction with the services rendered. The terminal includes a keyboard that displays inquiries to a respondent with multiple-choice responses for each inquiry.

U.S. patent application Ser. No. 2001/0052122 discloses an automated survey kiosk. The kiosk displays survey inquiries, receives survey responses, stores the survey responses, and transmits the survey responses to a remote location at predetermined intervals.

Electronic survey systems using portable input devices are also known. U.S. Pat. No. 5,054,112 discloses a data collection system that includes portable data entry devices and an information data processing apparatus communicating with one of the portable data entry devices by airwave transmission. The data collection system has a radio communication mode and an electromagnetic induction communication mode, and may change from one mode to the other when errors occur during communication.

U.S. Pat. No. 5,740,035 discloses a self-administered survey device that includes display means, input means for entering survey response data, memory means, and control means operative to determine whether a response received by the input means is within a set of predetermined acceptable responses.

A hand-held survey device that may be incorporated into a restaurant check book is disclosed in U.S. Pat. No. 6,380,928. The device includes a display, an input keypad, non-volatile data storage, a microprocessor, a self-contained power supply, a communications link, and a control program executing on the microprocessor. In use, a restaurant customer is prompted by their server to complete the survey using the survey device upon receiving their check at the end of a meal. The device may be used repeatedly and data is transferred to a personal computer via a cable.

U.S. patent application Ser. No. 2002/0147850 discloses an electronic system for knowledge and information sharing that includes a central electronic information network having a central database and a plurality of portable client devices for use by a mobile personnel in the field. Intermittently and preferably wirelessly, such as whenever a given client device connects to the central network for any reason, each client device synchronizes its logic tree data objects with those in the central database. In this manner, updates to the cumulative knowledge or information owned by a particular organization and stored in the central database is reflected in substantially all field personnel's client devices without need for an online communication connection or a manual synching.

In short, there are a variety of ways in which businesses and other entities seek feedback from customers and users as to their satisfaction or opinions. The above systems, however, suffer from a variety of drawbacks, namely poor response rate, incomplete or inconsistent data reporting, limited system and device mobility, rigid format, and delayed communication schemes. As such, there is a need for an electronic data collection system that is mobile, user friendly, dependable, and adaptable to a multitude of locations and communications availability while providing fast and efficient analyses and results.

### SUMMARY OF THE INVENTION

The present invention substantially meets the aforementioned needs of the industry by providing an electronic data collection system that comprises an integrated hardware and software system. The software tools allow users to quickly build and implement electronic data collection systems. The hardware system enables mobile and flexible implementation of the software-built electronic data collection system.

The system of the present invention is a complete set of software tools with corresponding hardware that allow users to quickly build and implement electronic data collection (“EDC”) systems. EDC is used to collect specific defined data in a decentralized manner while bringing the data back to a central location for a variety of uses. Some basic examples of EDC are surveys, inspections, registrations, service work, and time keeping. EDC uses various types of hardware devices such as standard PCs, tablet PCs, notebook PCs, kiosks, cell phones and personal digital assistants (“PDAs”) in the collection of data.

The system of the present invention comprises a manager module that registers and defines each of the hardware devices in the system individually and optionally in logical device groups. The manager module logically assigns one or more of the individual data collection applications to specific devices or device groups. Each device or device group preferably runs a device module to retrieve the data collections applications assigned to it. Once data collection applications are on the device, the device operator uses the device module to execute the applications and store the resulting data on the device until such time as the user instructs the device module to communicate the data to a central location.

A host module is resident on a server in a central location waiting to receive and process the data from the devices. The host module is able to decipher which particular data collection device and application was used to collect the data along with the data itself. The system determines what action to take with the data based on rules defined in a system builder module for that specific application.

Once the data is received, it is optionally stored in a database. All data stored is available to be queried and reported on using a query module. The system of the present invention is unique in the way it enables EDC systems to be rapidly created, dynamically deployed, and selectively managed. The system is also unique in the way it receives and processes the data by triggering logical events immediately upon receipt.

The above summary of the present invention is not intended to describe each illustrated embodiment or every implementation of the present invention. The following figures and detailed description more particularly exemplify the embodiments of the present invention.

### BRIEF DESCRIPTION OF THE DRAWINGS

The invention may be more completely understood in consideration of the following detailed description of various embodiments of the invention in connection with the accompanying drawings, in which:

FIG. 1 is an operating diagram of one embodiment of an electronic data collection system in accordance with the invention.

FIG. 2 is a flow diagram of one embodiment of an electronic data collection system in accordance with the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

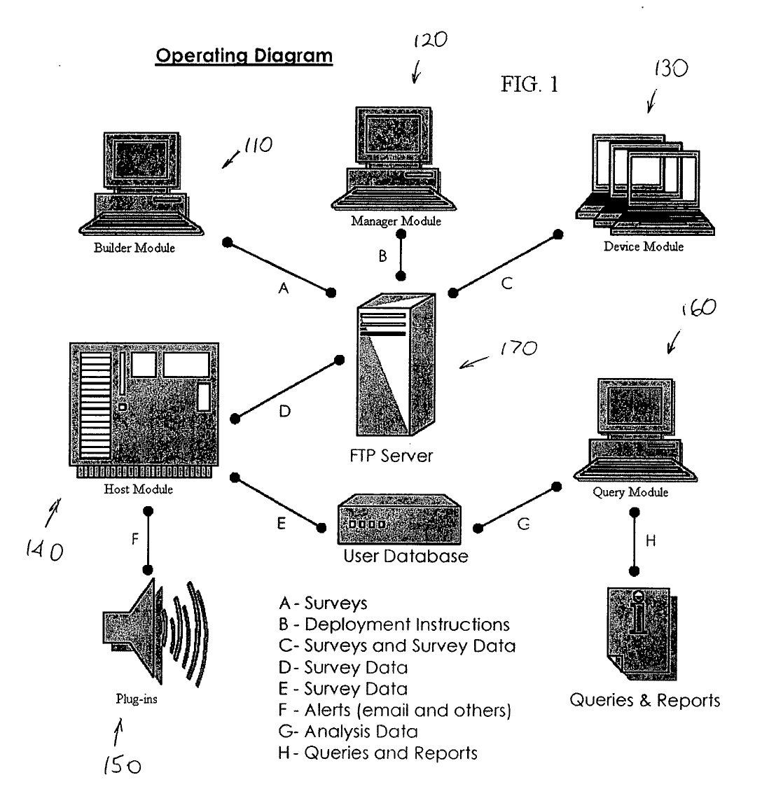

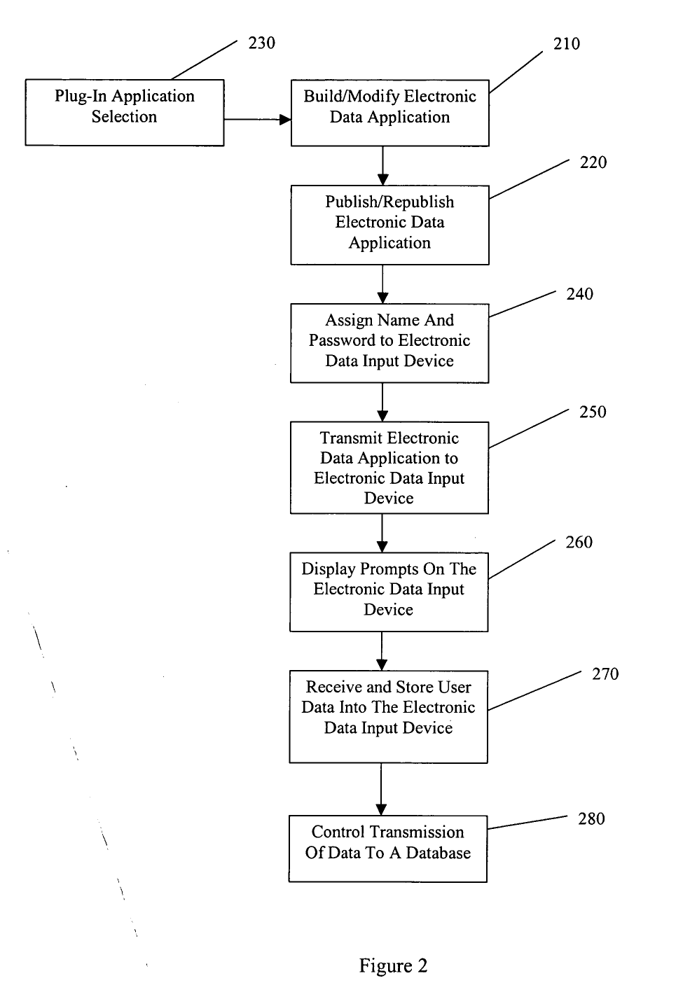

The invention can be more readily understood by reference to FIGS. 1-2 and the following description. While the invention is not necessarily limited to such applications, the invention will be better appreciated using a discussion of example embodiments in such a specific context.

The system of the invention preferably consists of five discrete software modules operating in conjunction with corresponding hardware. While each module is able to work independently of the others, it is the interaction of these modules that makes up a complete electronic data collection system in accordance with a preferred embodiment of the present invention. The discrete modules will be described below individually, with description as to each module's preferable interaction with the system as a whole included where relevant.

### Builder Module

Referring to FIG. 1 and step 210 of FIG. 2, data collection applications are preferably defined and built using a builder module 110 and stored in an XML format that is both encrypted for security and compressed for efficiency. Data collection applications generally consist of serialized sets of prompts and expected data responses. For each data item collected, there is a text prompt that describes the data and a data form to receive the data. An example of a prompt might be “Select your age group from the list below: under 21, 22-65, over 65.” An example of a data response might be a checked selection next to one of the three responses. The builder module 110 provides a number of standard prompt and response forms to select from that allow prompt content to be entered and a selection of predetermined response types or directly entry of variable information.

Data is preferably collected serially until finished with a set of data that makes up a single transaction. In some cases, there may be a need for logical branching within a single transaction. This logical branching is based on testing the data itself. When the data meets a simple test, a branch may occur to a different prompt than the prompt that would normally follow the serialized flow of prompts. For example, a data response indicating the over 65 age group that would cause a logical branch to a prompt about retirement.

As these data collection applications are built using the builder module 110, they may be stored locally and retrieved at any time to make changes. The builder module 110 allows stored applications to be copied to new names, changed, and stored again. As illustrated in step 220 of FIG. 2, once a data collection application is ready to be used with the other system modules, it is published with a publishing application.

Publishing an application at step 220 includes giving it a unique combination of a name and a version number, insuring that there is only one instance of this application on the system. If any changes to the published application are necessary the builder module 110 preferably republishes the application with a new name and/or version number. The builder module 110 thus enables data collection applications to be built very quickly without the technical programming that is generally associated with software applications.

The builder module 110 preferably allows for an optional contact feature for each data collection. If this contact feature is selected, a contact must be entered and selected external to the application from a contact list on the device when the data collection application is executed in the field. This contact is then stored along with the data that is collected from the data collection application itself.

As illustrated in step 230 of FIG. 2, the builder module 110 also preferably allows for the optional selection of plug-ins or plug-in applications to be included with any data collection application. Plug-ins are unique sub-applications that will initiate a particular action to be taken once data is collected and communicated to the central collection site. Various plug-ins are described in more detail below.

### Manager Module

As illustrated in step 240 of FIG. 2, specific user devices or electronic data input devices are named, registered, and catalogued into the system with a manager module 120 indicated in FIG. 1. In one embodiment, only these registered devices will be able to receive the data collection applications that have been published by the builder module 110 and only these devices will be allowed to communicate data back to the system to provide security and maintain the integrity of the system.

Each device is preferably provided a specific name and password. This insures that only registered devices have access when they connect into the system. The device names and access passwords are entered into a database through the manager module 120 and preferably only the manager module 120 may make changes to these names and passwords. The manager module 120 may group individual devices into logical device groups by providing a unique group name and linking each of the individual devices to it. The device groups are used to deploy data collection applications to a number of devices at one time, similar to the group function currently available in email programs.

Referring to step 250 of FIG. 2, the manager module 120 also serves as the management tool to determine and assign which data collection application will be deployed to any given user or user within a user group. To do this process, the manager module 120 has access to all published applications and makes logical links between the applications and the devices. The manager module 120 also has the ability to remove the links. If a link is added or removed from any device or user group, a new “map file” is stored for each user device affected. This map file contains all of the specific applications that are to be on that named device. The manager module 120 verifies that all of the applications in the individual maps are in fact resident and available for the devices. Device Module

While the builder module 110 creates the data collection applications and the manager module 120 registers devices and assigns the data collection application to each device, it is a device module 130 that actually runs the applications on the devices themselves. The device module 130 is a thin-client program that runs on various devices including, but not limited to, standard PCs, notebook and laptop PCs, tablet PCs, kiosk PCs, PDAs and mobile phones. The device module 130 is preferably loaded once onto each device. Once loaded, the device module 130 is the control software that manages all activities on the device.

Referring to step 260 of FIG. 2, the device module 130 displays all of the data collection applications that have been assigned to it by the manager module 120. Preferably, any application can be chosen and executed. When an application is chosen, the device module 130 retrieves the XML application from local storage and coverts the application instructions into the screens and logic that was defined by the builder module 110.

As the device module 130 executes its first data collection application, a local session data file is opened to output and store the data that is entered. First, the device information is stored in the data file, then the application name and version are stored. As the data collection application is operating, all of the data collected is also stored in the data file. All data is preferably date and time stamped.

Once a data collection application has completed, the session file is ready for another data collection application to run, with any new data appended to the data previously stored. The number of data collection applications that may be run is preferably limited only by the capacity of the device itself. The device does not need to be connected to any other computer or network during this process because of the store and forward feature. The store and forward feature enables a device to store multiple sessions or groups of data and send, or forward, the data at any time at an operator's discretion.

The device module 130 preferably encrypts all data for security and compresses all data for efficiency. In a preferred embodiment, the operator may instruct the device module 130 to connect to the host at any time. To do so, the device module 130 is provided a conduit to the host's FTP site.

This conduit is preferably an Internet or network connection. The conduit is preferably connected through a wired connection, wireless 802.11 connection, a land line modem connection, a cable modem, a cellular data connection, or some other type of Internet connection. Once a connection is made, the device module 130 communicates the session data file to the host.

During each connection session and after data is sent, the device module 130 retrieves the map file that was created and staged by the manager module 120. This map file describes all of the data collection applications that are assigned to this particular device. The device module 130 reads this map file and compares the applications that are on the device to the applications that the map file indicates.

If the device has an application that is not included in the map file, the device module 130 preferably removes it from the device. If there are applications in the map file that are not on the device, the device module 130 then retrieves that application from the host. The device module 130 then checks the map file to determine if the device module 130 itself has changed. If so, the device module 130 retrieves the new device module from the host and, in effect, replaces itself with the new device module 130.

### Host Module

As session data files are being sent from the device module 130, there is an application waiting to process this data called a host module 140. The host module 140 preferably runs on a continuous basis, polling to see if session data files have been received from the device module 130.

Referring to step 270 of FIG. 2, once the system detects a session data file, it retrieves the file and opens it to determine what is inside. Each session data file contains the device name that sent it followed my one or more sets of EDC application data that were collected for that device, one set for each instance that a builder module application was run on the device module 130.

Each of these sets of data begins with the builder module application name and version number followed by the actual data collected that is relative to that application and version. The host module 140 retrieves the builder module application information for each set to determine what to do with the data as defined by the plug-ins selected when the builder module application was built. The host module 140 then retrieves the appropriate plug-in and executes it. When finished with one data set, the host module 140 moves on the to the next data set until all data in the session data file has been processed.

### Plug-Ins

Each specific data collection application is conducted for its own unique purpose. The system of the present invention has been engineered to allow each data collection application to trigger its own unique action. These unique actions are defined and programmed as sub-applications called plug-ins 150. As a data collection application is created with the builder module 110, the builder module 110 allows the selection of one or more plug-ins 150 to instruct the host module 140 as to what to do with the data collected once the application has been executed and the corresponding session data has been sent to the host module 140.

A variety of plug-ins 150 may be implemented on the system of the present invention. For example, an email plug-in 150 causes the data set to be combined with the corresponding builder module application prompts into a format suitable for email. One or more email addresses may be entered in the builder module 110 for any given application. A contact may also be selected when executing the application on the device module 130. This contact may also have an email address attached. The formatted text message is then preferably immediately emailed to each of these embedded email address for that data set.

Referring to step 280 of FIG. 2, a database plug-in 150 formats data from a given data set and outputs that data to a standard SQL database. Once in a standard database, the information may be queried, reported on, or exported to any external entity based on specific user requirements.

The flexible design of the system of the present invention allows any number of new plug-ins 150 to be developed and implemented. Some additional examples of plug-ins 150 include an SMS plug-in 150 that sends visual or audible Short Message Service (SMS) notifications to defined cell phones, pagers, or other SMS enabled devices. A pager plug-in 150 may trigger a page to a specified device. An integration plug-in 150 is a specific plug-in that preferably immediately integrates a data set into another application. This plug-in provides a seamless interface between disparate systems. Each plug-in 150 would preferably be unique to the data set and external system being integrated.

### Query Module

In most cases, the collected data will we be stored in the SQL database with the standard database plug-in 150. While this data may be stored and used for many application specific uses, a query module 160 preferably provides the tools necessary to easily select and retrieve data from the database and present the data either as a report or output into a named data file. The data may be requested in a comma or tab delimited format.

### System Architecture

The system architecture is flexible by design to allow for different levels of implementation activity. The design preferably allows a minimum configuration to support a small implementation and a scalable configuration for larger implementation.

Each of the system modules at certain times preferably connects to other system modules. This connection is preferably via an FTP server 170 gateway. The FTP server 170 uses one consistent file transfer protocol for sending and receiving files. The FTP server 170 will also hold a database that is used to control certain management functions of the system of the present invention.

The builder module 110 may run on any individual PC running select MICROSOFT WINDOWS operating systems. The only required connectivity is preferably at the time that the builder module 110 publishes a data collection application. When publishing, the builder module 110 connects to a specific IP address of an FTP server 170. Once published applications are copied to the FTP server 170, the connection is no longer necessary.

The manager module 120 may run on any individual PC running select MICROSOFT WINDOWS operating systems. When operating the manager module 120, the PC is preferably connected to the FTP server 170. As user devices are registered and builder module applications assigned, all data is stored in a database on the FTP server 170.

Each device module 130 is able to operate remotely without connectivity to any other system while it is executing the builder module applications. All data collected is stored locally on the device. To communicate the session data and to synchronize the builder module applications on the device, the device preferably connects to the FTP server 170.

The host module 140 is preferably continually connected to the FTP server 170 to immediately respond to any and all session data files received from a device module 130. As the host module 140 executes the plug-ins, the plug-ins themselves dictate and direct the connectivity to any other external databases, systems, or devices.

The query module 160 does not require connectivity to the FTP server 170 or other system modules. The query module 160 preferably runs independently by accessing only a standard SQL database 180.

Although the present invention has been described with reference to particular embodiments, one skilled in the art will recognize that changes may be made in form and detail without departing from the spirit and the scope of the invention. Therefore, the illustrated embodiments should be considered in all respects as illustrative and not restrictive.

1. An electronic data collection system comprising:
at least one electronic data input device having at least one device module stored therein;
at least one data collection application storable on the at least one electronic data input device and controllable by the device module, the at least one data collection application having at least one generally serialized set of displayable prompts and expected data responses defining a transaction, the serialized set of displayable prompts having a logical branching of displayable prompts that are generally dependent upon a previously entered response;
a manager module in communication with the at least one electronic data input device to manage operation of the at least one electronic data input device;
a host module in communication with the at least one electronic data input device to receive and process the data from the at least one electronic data input device, wherein the host module is capable of determining the at least one electronic device, the data collection application and the data; and
a server in communication with the host module, manager module and the at least one electronic data input device.

2. The electronic data collection system of claim 1, further including a builder module to build the at least one data collection application.

3. The electronic data collection system of claim 1, wherein for each data collected, there is a text prompt describing the data and a data form.

4. The electronic data collection system of claim 2, wherein the builder module creates a plurality of data collection applications that are transferable to the at least one electronic data input device.

5. The electronic data collection system of claim 4, further including a plurality of electronic data input devices, wherein each of the electronic data input devices receives at least one of the data collection applications.

6. The electronic data collection system of claim 1, further including at least one plug-in application, wherein the plug-in application initiates a particular action to be taken once data is collected and communicated to the server.

7. The electronic data collection system of claim 5, wherein each of the electronic data input devices has a generally particular name and password designated by the manager module, whereby only electronic data input devices with the particular name and password can communicate with the system.

8. The electronic data collection system of claim 1, wherein the electronic data input device consists of at least one selected from the group consisting essentially of a standard personal computer, a notebook and laptop personal computer, a tablet personal computer, a kiosk personal computer, a personal digital assistant, and a mobile phone.

9. The electronic data collection system of claim 1, further including a transceiver device coupled to the at least one electronic data input device to transmit and receive data, wherein the transceiver device is at least one selected from the group consisting essentially of a wired connection, a wireless connection, a land line modem connection, a cable modem, a cellular data connection, or some other type of Internet connection.

10. The electronic data collection system of claim 1, wherein the plug-in is selected from the group consisting essentially of an email plug-in that causes the data to be combined with a corresponding builder module application that places the data in a suitable format for email, a database plug-in formats data and outputs that data to a standard SQL database, an SMS plug-in that sends visual or audible short message service notifications to defined cell phones, pagers, and other SMS enabled devices, a pager plug-in that triggers a page to a specified device, an integration plug-in that generally immediately integrates data into another application.

11. The electronic data collection system of claim 1, further including a query module adapted to permit a user to select and retrieve data from a database and to present the data.

12. The electronic data collection system of claim 1, wherein the server includes an FTP server gateway having a database, wherein data collection applications and received data are at least temporarily storable.

13. A method of electronic data collection, the method comprising the steps of:
building at least one data collection application with a builder module storable on an electronic storage device;
publishing and storing the data collection application with a publishing application storable on an electronic storage device;
assigning at least one name and password to at least one electronic data input device with a manager module storable on an electronic storage device;
transmitting the at least one data collection application to the least one electronic data input device;
displaying a serialized set of displayable prompts and expected data responses on the at least one electronic data input device;
altering the serialized set of displayable prompts depending upon a previously entered response;
polling the at least one electronic data input device by a host module storable on an electronic storage device; and
storing the data on a database.

14. The method of claim 13, further including the step of connecting the builder module to a an FTP server and copying the electronic data applications thereto.

15. The method of claim 1, further including providing a device module resident on the at least one electronic data input device to operate the at least one electronic data application.

16. The method of claim 1, further including the step of initiating connection between the at least one electronic data input device and a FTP server, whereby data stored in the at least one electronic device is transmitted thereto.

17. The method of claim 16, further including the step of providing at least one plug-in application generally in communication with the at least one electronic data application, whereby the at least one plug-in instructs the host module to communicate with other modules of the system.

18. The method of claim 1, further including the step of providing a query module storable on an electronic storage device that is in communication with the data stored on a database.
